(19) United States
(12) Patent Application Publication
(10) Pub. No.: US 2023/0254301 A1
(43) Pub. Date: Aug. 10, 2023

(54) Auto-Configuration of Security Features in Distributed System with Minimal User Interaction

(71) Applicant: Elasticsearch B.V., Mountain View, CA (US)

(72) Inventors: Tim Vernum, Sydney (AU); Ioannis Kakavas, Athens (GR)

(21) Appl. No.: 17/666,380

(22) Filed: Feb. 7, 2022

(51) Int. Cl. H04L 9/40

(52) U.S. Cl. CPC H04L 63/0823; H04L 63/20; H04L 63/083

(57) ABSTRACT

Provided are methods and systems for auto-configuration of security features in a distributed system. An example method includes determining that a component of the distributed system needs to be installed on a computing node; in response to the determination, acquiring network environmental parameters associated with the computing node; generating digital certificates and digital keys associated with the digital certificates; storing the network environmental parameters, the digital certificates, and the digital keys to one or more configuration files associated with the component; generating an enrollment token and a user password for accessing the component by a user; initiating the component on the computing node; and assigning the computing node as an initiating node of a cluster. The enrollment token includes the network environment parameters, a fingerprint associated with the digital certificates, and authentication credentials and is used for installing a further component of the distributed system.

### TECHNICAL FIELD

This disclosure relates to computer security. More specifically, this disclosure relates to systems and methods for auto-configuration of security features in a distributed system with minimal user interaction.

### BACKGROUND

Providing security for network communications between user devices and remote computing resources, such as servers and clusters, has proven to be a challenging task. The remote computing resources can be vulnerable to unauthorized access by malicious users. Additionally, users may run unsecured clusters which are open to the Internet and, unintentionally, exposing the user data. Specifically, clusters can become vulnerable because of software that does not have security enabled when deployed.

### SUMMARY

This summary is provided to introduce a selection of concepts in a simplified form that are further described in the Detailed Description below. This summary is not intended to identify key features or essential features of the claimed subject matter, nor is it intended to be used as an aid in determining the scope of the claimed subject matter.

Generally, the present disclosure is directed to a technology for auto-configuration of security features in a distributed system with minimal user interaction.

Some embodiments of the present disclosure may provide security features of a component of the distributed system by default, during installations of the components on clusters. Some embodiments of the present disclosure may provide protection of user data in the clusters from unauthorized use.

According to one example embodiment of the present disclosure, a method for auto-configuration of security features in a distributed system is provided. The method may include determining that a component of the distributed system needs to be installed on a computing node. In an example embodiment, the determination that the component of the distributed system needs to be installed on the computing node may include determining that the user has entered a predetermined command via a user interface.

The method may include acquiring environmental network parameters associated with the computing node in response to the determination that the component of the distributed system needs to be installed on the computing node. The network environment parameters may include one or more of the following: a port of the computing node, an Internet Protocol address of the computing node, a hostname associated with the computing node, and so forth. The method may include generating one or more digital certificates and one or more digital keys associated with the digital certificates.

The method may allow storing the network environmental parameters, the digital certificates, and the digital keys to one or more configuration files associated with the component. The method may include generating an enrollment token and a user password for accessing the component by a user. The enrollment token may include the network environment parameters and a fingerprint associated with the one or more digital certificates. The method may include initiating the component on the computing node and assigning the computing node as an initiating node of a cluster.

The method may further include presenting, via a user graphic interface, the user password, the enrollment token, and the fingerprint of the digital certificates to the user.

The method may further include determining that a client of the distributed system needs to be connected to the component on the computing node. The determination that the client of the distributed system needs to be connected to the computing node may include determining that the user has entered a predetermined command via a user interface. The predetermined command may include the enrollment token as a parameter.

In response to the determination that the client of the distributed system needs to be connected to the computing node, the method may continue with extracting, from the enrollment token, the network environment parameters, the fingerprint of the one or more digital certificates, and authentication credentials. The authentication credentials may include an Application Programming Interface (API) key. The method may include establishing, based on the network environment parameters, a network connection between the client and the component on the computing node, and authenticating, using the API key, the client to the component on the computing node. The method may further include verifying that the fingerprint of the one or more digital certificates is valid. The method may include retrieving a further user password associated with the client and a digital certificate after establishing that the fingerprint is valid. The method may continue with storing the further user password and the digital certificate to one or more further configuration files associated with the further component. The method may also include initiating the client on the computing node. The digital certificate can be used to establish a secure communication between the client and the component at a Hypertext Transfer Protocol (HTTP) layer.

The method may further include determining that a further component of the distributed system needs to be installed on a further computing node. The determination that the further component of the distributed system needs to be installed on the computing node may include determining that the user has entered a predetermined command via a user interface. The predetermined command may include the enrollment token as a parameter. In response to the determination, the method may continue with extracting, from the enrollment token, the network environment parameters, and the fingerprint of the one or more digital certificates, and authentication credentials. The authentication credentials may include an API key. The method may include establishing, based on the network environment parameters, a network connection between the further computing node and the computing node and authenticating the further computing node using the API key. The method may also include verifying that the fingerprint of the digital certificate is valid. The method may include retrieving further digital certificates and keys from the computing node and generating a further digital certificate and a further key associated with the one or more further certificates after verifying that the fingerprint is valid.

The method may further include storing further digital certificates and further keys that were retrieved or generated to one or more further configuration files associated with the further component. The method may continue with initiating the further component on the further computing node. The method may include adding the further computing node as a next node to the cluster. The retrieved digital certificates can be used to establish secure communications between the computing node and the further computing node at the transport layer. The generated further digital certificates can be used to establish secure communications between a client and the further component at the HTTP layer.

According to another embodiment of the present disclosure, a system for auto-configuration of security features in a distributed system is provided. The system can comprise a cluster including one or more nodes. The nodes can be configured to implement operations of the above-mentioned method for auto-configuration of security features in a distributed system.

According to yet another example embodiment of the present disclosure, the operations of the above-mentioned method for auto-configuration of security features in a distributed system are stored on a machine-readable medium comprising instructions, which, when implemented by one or more processors, perform the recited operations.

Other example embodiments of the disclosure and aspects will become apparent from the following description taken in conjunction with the following drawings.

### BRIEF DESCRIPTION OF DRAWINGS

Exemplary embodiments are illustrated by way of example and not limitation in the figures of the accompanying drawings, in which like references indicate similar elements.

FIG. 1 is a block diagram of an example environment suitable for practicing methods for auto-configuration of security features in a distributed system as described herein.

FIG. 2 is a schematic showing installation of a component of a distributed system and initiating a cluster, according to some example embodiments.

FIG. 3 is a schematic showing installation of a copy of a component of a distributed system and adding a node to a cluster, according to some example embodiments.

FIG. 4 is a schematic showing installation of another component of a distributed system, according to some example embodiments.

FIG. 5 is an example screen of a user interface during installation of a component of a distributed system and initiating a cluster, according to some example embodiments.

FIG. 6 is an example screen of a user interface during installation of another component of a distributed system, according to some example embodiments.

FIG. 7 is a flow chart of an example method for auto-configuration of security features in a distributed system, according to some example embodiments.

FIG. 8 is a flow chart of an example method for auto-configuration of security features of a client of a distributed system, according to some example embodiments.

FIG. 9 is a flow chart of an example method for auto-configuration of security features of an additional node in a distributed system, according to some example embodiments.

FIG. 10 is an example computer system that can be used to implement some embodiments of the present disclosure.

### DETAILED DESCRIPTION

The technology disclosed herein is concerned with methods and systems for auto-configuration of security features in a distributed system. Embodiments of the present disclosure may facilitate enabling the security features of components of the distributed system by default during installations of the components in clusters. Some embodiments of the present disclosure may provide protection of user data in clusters from unauthorized use.

Embodiments of the present disclosure are directed to methods and systems for auto-configuration of security features in a distributed system with minimal user interaction. Some embodiments of the present disclosure may enable the security features of components of the distributed system, by default, during installation of the components on clusters.

Conventional systems may have identical default security configurations enabled when shipped. The default credentials in such conventional systems can create a false sense of security because the default credentials can be easily ascertained. Moreover, network encryption using default asymmetric key pairs can be used to impersonate a server and, for example, mount Man-In-The-Middle attacks.

The systems and methods of the present disclosure enable and automatically configure authentication, authorization, and network encryption for a distributed system. Specifically, embodiments of the present disclosure allow authentication of components of the distributed system and enabling network encryption between the components during installation. This may protect user data from unauthorized use, ensure data confidentiality and integrity, and provide network encryption between system components and between clients and the system. Moreover, when compared to conventional systems that enable transport layer security (TLS) utilizing automated open certificate authorities, the systems and methods of the present disclosure do not require a component accessible publicly over the Internet, provide support for bootstrapping trust between multiple components of the system using a TLS protocol, and configure authentication in addition to TLS.

While some embodiments of the present technology are described herein with reference to components of Elasticsearch Stack Software, such as Elasticsearch (a search engine) and Kibana (data visualization dashboard software for the Elasticsearch component), the present technology can be practiced with any distributed software system installed on a cluster of computing nodes.

Some embodiments automatically configure the TLS protocol for the transport layer and HTTP layer of the Elasticsearch cluster and setup authentication for the elastic superuser. After initiating a first node in a cluster, users can be provided with a password for the elastic superuser and an enrollment token. The password for the other built-in users can be set, if needed, using an existing password-reset tool, or by using the Change Password application programming interface (API).

The enrollment tokens can be used to enroll new nodes into the cluster securely and to allow other stack components to set up secured communication with the Elasticsearch cluster. For instance, the enrollment token can be used to automatically enable and configure authentication and network encryption between Kibana and Elasticsearch, auto-generate and configure a password for a system user and configure Kibana to trust Elasticsearch in the context of TLS.

According to one example embodiment of the present disclosure, a method for auto-configuration of security features in a distributed system may include determining that a component of the distributed system needs to be installed on a computing node. In response to the determination, the method may continue with acquiring network environmental parameters associated with the computing node. The method may include generating one or more digital certificates and one or more digital keys associated with the digital certificates. The method may allow storing the network environmental parameters, the digital certificates, and the digital keys to one or more configuration files associated with the component. The method may include generating an enrollment token and a user password for accessing the component by a user. The enrollment token may include the network environment parameters, a fingerprint associated with the one or more digital certificates, and authentication credentials (an API key). The method may also include initiating the component on the computing node and assigning the computing node as a starting node of a cluster.

Referring now to the drawings, various embodiments are described in which like reference numerals represent like parts and assemblies throughout the several views. It should be noted that the reference to various embodiments does not limit the scope of the claims attached hereto. Additionally, any examples outlined in this specification are not intended to be limiting and merely set forth some of the many possible embodiments for the appended claims.

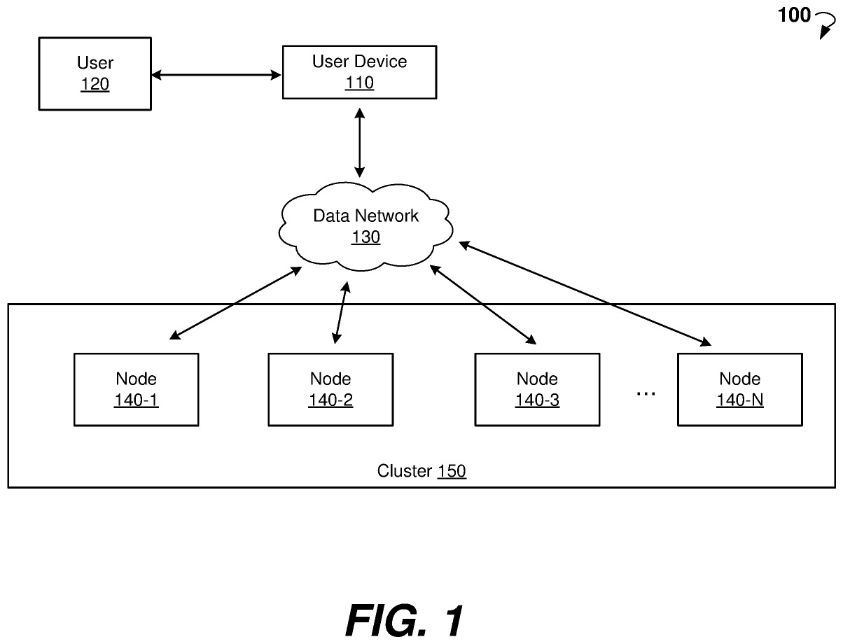

FIG. 1 shows a block diagram of an example environment 100 suitable for practicing methods described herein. It should be noted, however, that the environment 100 is just one example and is a simplified embodiment provided for illustrative purposes, and reasonable deviations of this embodiment are possible as will be evident to those skilled in the art.

As shown in FIG. 1, the environment 100 may include a user device 110, a user 120 associated with the user device 110, a data network 130, and computing node(s) shown as node(s) 140-i, (i=1, . . . , N). The computing node(s) may form a cluster 150. In various embodiments, the user device 110 may include, but are not limited to, a laptop computer, a tablet computer, a desktop computer, and so forth. The user device 110 can include any appropriate device having network functionalities allowing the user device 110 to communicate to the node(s) 140-i, (i=1, . . . , N). In some embodiments, the user device 110 can be connected to the node(s) 140-i, (i=1, . . . , N) via the data network 130. The node(s) 140-i, (i=1, . . . , N) can be also connected to each other via the data network 130.

The data network 130 may include the Internet or any other network capable of communicating data between devices. Suitable networks may include or interface with any one or more of, for instance, a local intranet, a corporate data network, a data center network, a home data network, a Personal Area Network, a Local Area Network (LAN), a Wide Area Network (WAN), a Metropolitan Area Network, a virtual private network, a storage area network, a frame relay connection, an Advanced Intelligent Network connection, a synchronous optical network connection, a 3G network, a 4G network, a 5G network, a digital T1, T3, E1 or E3 line, Digital Data Service connection, Digital Subscriber Line connection, an Ethernet connection, an Integrated Services Digital Network line, a dial-up port such as a V.90, V.34 or V.34bis analog modem connection, a cable modem, an Asynchronous Transfer Mode connection, or a Fiber Distributed Data Interface or Copper Distributed Data Interface connection. Furthermore, communications may also include links to any of a variety of wireless networks, including Wireless Application Protocol, General Packet Radio Service, Global System for Mobile Communication, Code Division Multiple Access or Time Division Multiple Access, cellular phone networks, Global Positioning System, cellular digital packet data, Research in Motion, Limited duplex paging network, Bluetooth radio, or an IEEE 802.11-based radio frequency network. The data network 130 can further include or interface with any one or more of a Recommended Standard 232 (RS-232) serial connection, an IEEE-1394 (FireWire) connection, a Fiber Channel connection, an IrDA (infrared) port, a Small Computer Systems Interface connection, a Universal Serial Bus (USB) connection or other wired or wireless, digital or analog interface or connection, mesh or Digi® networking.

In some embodiments, the one or more node(s) 140-i, (i=1, . . . , N) may be configured to run one or more applications that can be available to the user device 110. The user 120 of the user device 110 can access the applications on the cluster 150 using an Internet browser, a terminal application, and other applications configured to run on the user device 110.

In some example embodiments, the user 120 may download and run Elasticsearch and Kibana to the first node 140-1. The deployment of Elasticsearch and Kibana at the first run may automatically enable security features, such as user authentication, network encryption, and digital certificates. The deployment may generate enrollment tokens and setup the cluster 150 including, at beginning, only the first node 140-1. The user 120 may then add more nodes to the cluster 150 in a secure process using the user authentication and enrollment tokens. The user 120 may then make available the Kibana interface to the Internet, confident that it is secure, and give access to other users. The deployment can automatically take care of maintenance of security features, such as certificate expiration.

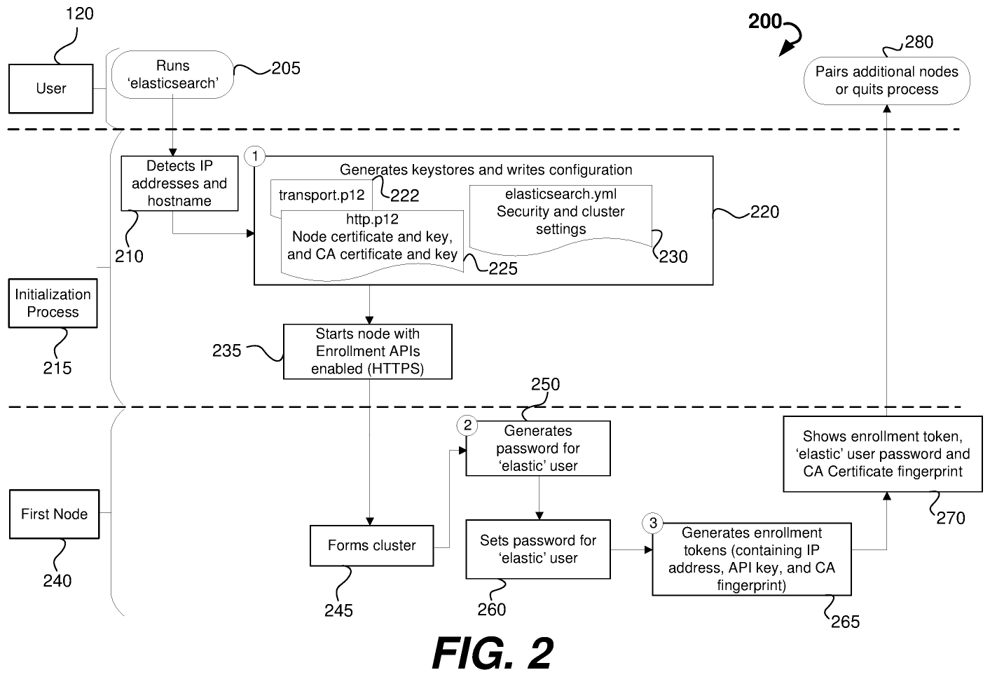

FIG. 2 is a schematic showing an installation process 200 of a component of a distributed system and initiating a cluster, according to some example embodiments. A user 120 may run a search engine shown as Elasticsearch in block 205.

In block 210, a process of initialization shown as an initialization process 215 detects Internet Protocol (IP) addresses and a hostname associated with the Elasticsearch node. In block 220, the initialization process 215 performs step 1 that includes generating a certification authority (CA) certificate and a digital key for the transport layer and uses the CA certificate and the digital key to sign the digital certificate and a digital key for the transport layer and stores that digital certificate and the digital key, along with the CA certificate in a keystore 222. The initialization process 215 also generates a certification authority (CA) certificate and a digital key for the HTTP layer and uses the CA certificate and the digital key to sign the HTTP layer certificate and the digital key of a node. Both key/certificate pairs are stored in a keystore 225. The initialization process 215 persists both files under the Elasticsearch configuration path. Finally, the initialization process 215 updates elasticsearch.yml in a store 230 to set transport TLS and HTTP TLS to use the newly created keystores, to set enrollment mode to ‘true’, and to set cluster.initial_master_nodes to the name of the first node so that the node can form its own cluster.

In block 235, the initialization process 215 starts the node (i.e., the component) with enrollment APIs enabled (HTTPS). The node shown as the first node 240 forms a cluster in block 245. The first node 240 generates a password for an ‘elastic’ user, i.e. the user 120, as shown in block 250.

In step 2 shown in block 250, the first node 240 generates password for an ‘elastic’ user when the first node 240 is started and if the password for the ‘elastic’ user has not been set already. In block 260, the first node 240 sets the password for the ‘elastic’ user.

In step 3 shown in block 270, the first node 240 generates an enrollment token for a data visualization dashboard software (i.e., Kibana) to use in order to configure itself to communicate and trust the secured Elasticsearch cluster. In an example embodiment, the enrollment token is not generated for Elasticsearch nodes because the nodes bind only to a local host for the transport layer and the token cannot be used on other hosts. The first node 240 returns the enrollment token containing the IP address, the API key, and the CA fingerprint. Specifically, the receiver of the enrollment token (Kibana) needs information that can allow Kibana to communicate securely with the first node 240 and make a request to the Enroll Kibana API. More, specifically, the list of necessary information includes:
An IP address or a hostname and a port number for the interfaces where the first node 240 is listening on for HTTP;
The fingerprint (Secure Hash Algorithm (SHA) 256) of the CA certificate that is used to sign the certificate that the first node 240 presents for the TLS on the HTTP layer. The holder of the enrollment token acting as a client in the context of TLS needs to validate that the enrollment token matches with the fingerprint of the CA certificate that is presented by the server (the first node 240) during the TLS handshake;
Credentials by which the holder of the enrollment token can authenticate itself to the first node 240. An API key is used for authentication because the API key can offer fine-grained privileges (e.g., a privilege to call the Enroll Kibana API only) and time-boxed validity (30 m).

In step 270, the initialization process 215 shows to the user the Kibana enrollment token, the elastic user password, and CA certificate fingerprint. In step 280, the user 120 can pair additional nodes or quit the process.

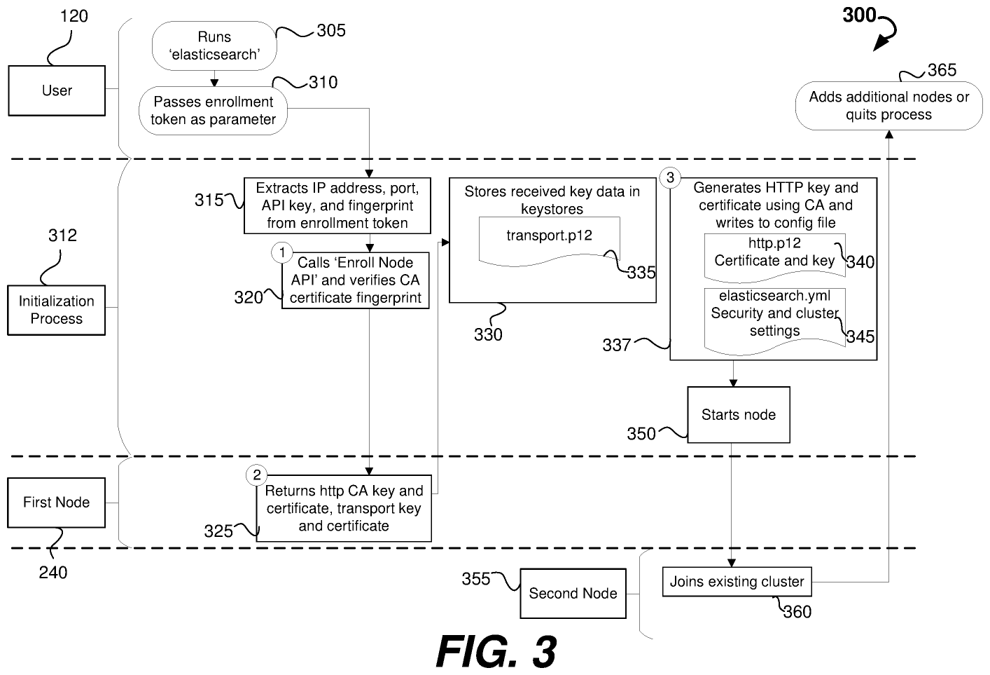

FIG. 3 is a schematic showing an installation process 300 of a copy of the component of the distributed system and adding a node to cluster, according to some example embodiments.

As shown in FIG. 3, a user 120 may run a search engine shown as Elasticsearch in block 305. In block 310, the user 120 may pass an enrollment token as a parameter. In block 315, a process of initialization of Elasticsearch shown as an initialization process 312 extracts an IP address, a port, an API key, and a fingerprint from the enrollment token.

In step 1 shown in block 320, the initialization process 312 makes a request (i.e., a call), over HTTPS, to the Enroll Node API using the information from the enrollment token. The information from the enrollment token includes the IP address and port where the Elasticsearch component accepts HTTP connections and the API key as authentication credentials for the request.

While making this request, the initialization process 312 validates the certificate that the first node 240 uses for TLS and verifies that the CA certificate fingerprint from the enrollment token matches the issuer of the certificate.

In step 2 shown in block 325, the first node 240 returns the response that contains the HTTP CA key and the certificate as a Base64-encoded string (Base64 is an encoding scheme) of the Distinguished Encoding Rules (DER)-encoded key and certificate. The response further includes the transport layer CA certificate and the transport layer key and the certificate as a Base64 encoded string of the DER encoded key and certificate. The response further includes the IP address and the transport port used for all nodes that are currently in the cluster. In block 330, the initialization process 215 stores the received transport layer CA certificate and transport layer key in a keystore 335.

In step 3, shown in block 337, the initialization process 215 process generates its own HTTP layer key and certificate using the HTTP CA certificate and key it retrieved above and stores the HTTP layer key and the certificate along with the HTTP CA certificate and key in a keystore 340. Finally, the initialization process 215 updates elasticsearch.yml in a file 345 to set the transport TLS and HTTP TLS to use the newly created keystores and to set discover.seed_hosts with the transport layer IP address and ports of other nodes received by the initialization process 215.

In block 350, the initialization process 215 starts a node (i.e., a copy of the component) shown as a second node 355. In block 360, the second node 355 joins the existing cluster. In step 365, the user 120 can pair additional nodes.

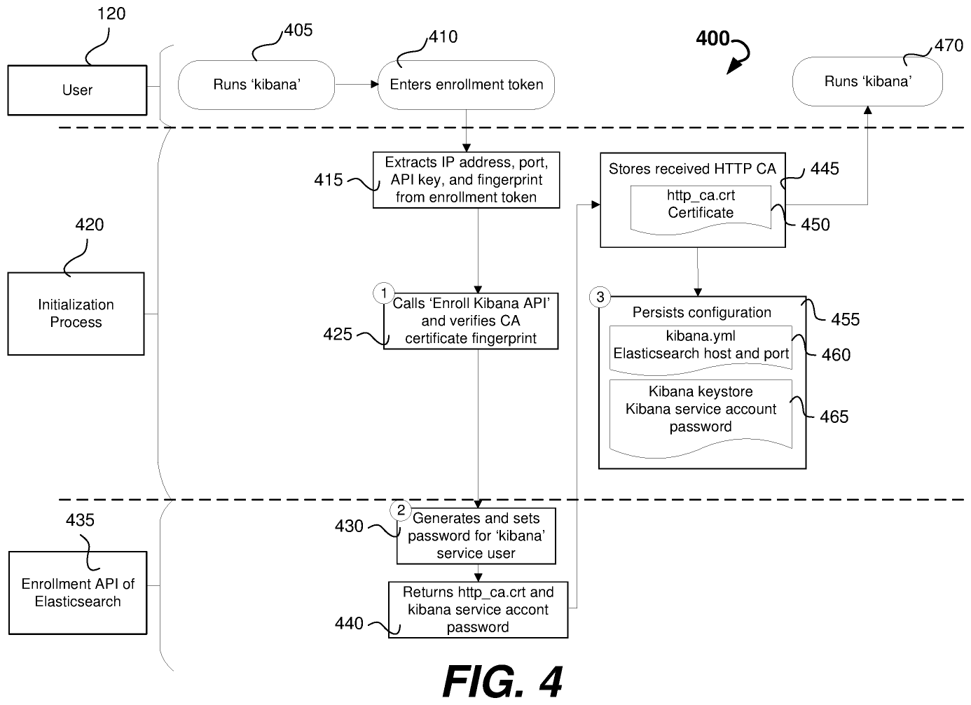

FIG. 4 is a schematic showing an installation process 400 of another component of the distributed system, according to some example embodiments. A user 120 may run a data visualization dashboard software shown as Kibana in block 405. In block 410, the user 120 may enter an enrollment token. In block 415, a process of initialization of Kibana, shown as an initialization process 420, extracts an IP address, a port, an API key, and a fingerprint from the enrollment token.

In step 1 shown in block 425, the initialization process 420 makes a request (i.e., a call), over HTTPS, to the Enroll Kibana API using the information from the enrollment token. The information from the enrollment token includes the IP address and the port where the Elasticsearch accepts HTTPS connections and further includes the API key as authentication credentials for the request. While making this request, the initialization process 420 validates the certificate that the first node uses for TLS and verifies that the CA certificate fingerprint matches the issuer of the certificate.

In step 2 shown in block 430, the enrollment API 435 of the Elasticsearch generates and sets a password for “kibana” service account. In block 440, the enrollment API 435 returns the password in the response along with the HTTP CA certificate as a Base64-encoded string of the DER encoded certificate. In block 445, the initialization process 420 stores the received HTTP CA certificate into a file 450.

In step 3 shown in block 455, the initialization process 420 persists the configuration in kibana.yml in a configuration file 460 and a keystore 465. The configuration may include:
The password for the kibana service account;
The Uniform Resource Locators (URLs) of the node which the initialization process 420 communicates to the Elasticsearch;
The trusted certificate that the initialization process 420 uses to validate the TLS certificate of the nodes; and
Data unrelated to cluster enrollment but used to set the encryption keys, such as xpack.security.encryptionKey, xpack.reporting.encryptionKey, and xpack.encryptedSavedObjects.encryptionKey.

In block 470, the user 120 may run Kibana as client of the distributed system.

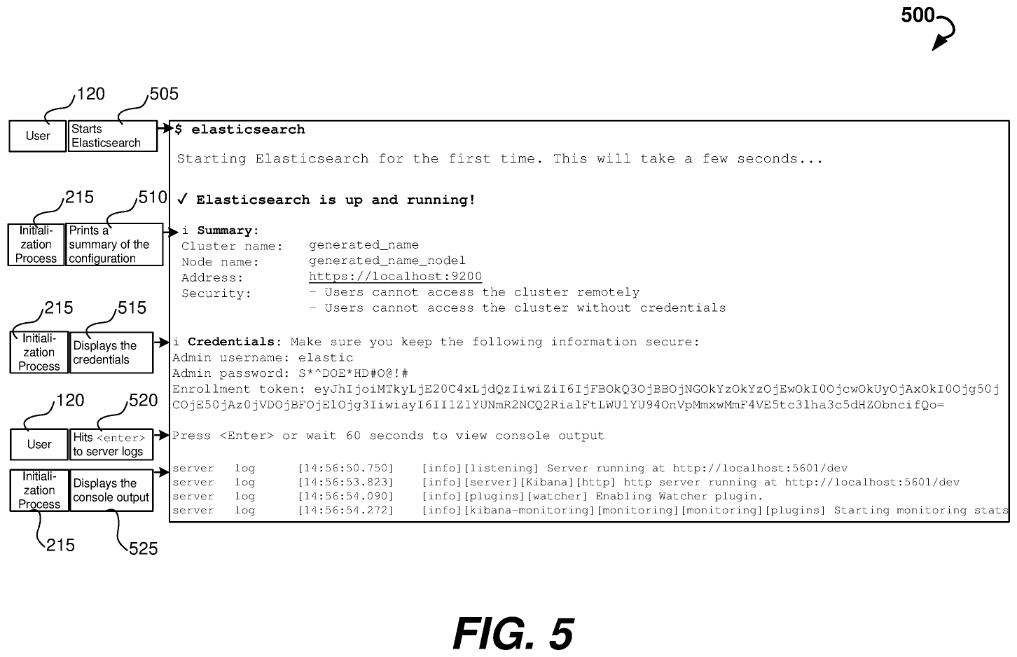

FIG. 5 is an example screen of a user interface 500 during installation of a component of a distributed system and initiating a cluster, according to some example embodiments. The user 120 may start the Elasticsearch in block 505. In response to the user request to start the Elasticsearch, the Elasticsearch is started and the user interface 500 shows that the Elasticsearch is running.

The initialization process 215 may print a summary of the configuration of the Elasticsearch in block 510. The summary may include a cluster name, a node name, an IP address, security parameters, and so forth. The initialization process 215 may display credentials on the user interface 500 in block 515. The credentials may include a user name, a password, and an enrollment token. In block 520, the user 120 may hit ‘enter’ to view server logs. In block 525, the initialization process 215 may display on the user interface 500 the console output with server logs.

The biggest challenge from a user experience perspective is ensuring that the generated credentials do not get lost amongst the rest of the console output and that users understand what settings have been applied, what consequences they have, and how they can reconfigure them if the defaults do not fit their needs. To address this issue, the console output may be suppressed for a predetermined time period or until the user confirms that users understand what settings have been applied.

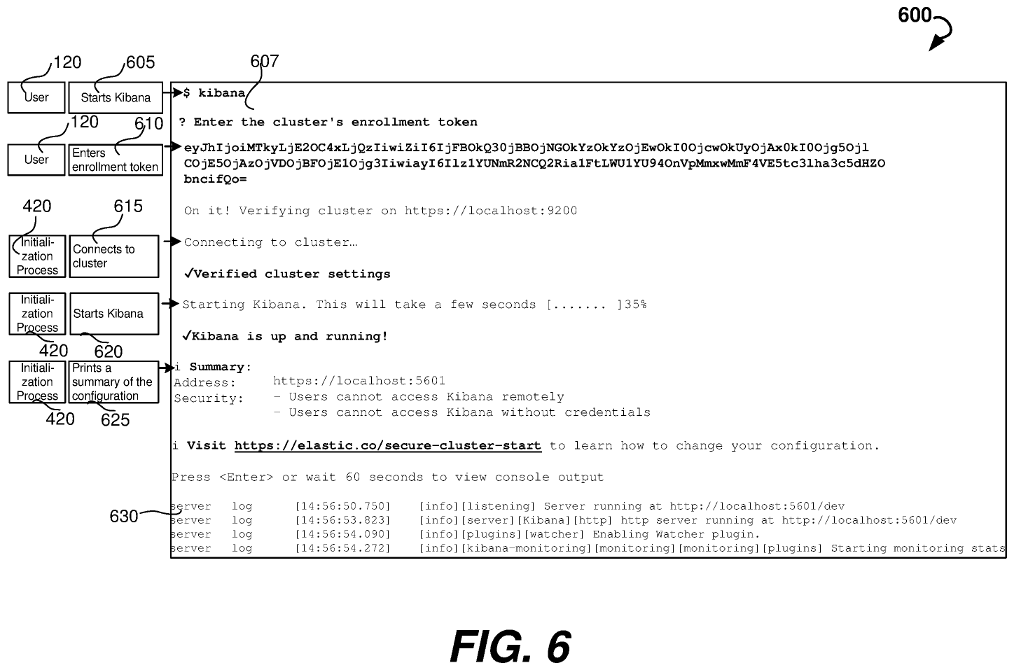

FIG. 6 is an example screen of a user interface 600 during installation of another component of a distributed system, according to some example embodiments. The user 120 starts Kibana in block 605. The user interface 600 may show a request 607 to enter an enrollment token of the cluster. In block 610, in response to the request 607, the user 120 may enter the enrollment token of the cluster.

In block 615, an initialization process 420 may be used to connect to the cluster. In block 620, the initialization process 420 may start Kibana. In block 625, the initialization process 420 may print, on the user interface 600, a summary of the configuration associated with Kibana. The summary may include an IP address and security parameters. After a predetermined time period, the initialization process 420 may display, on the user interface 600, a console output 630 with server logs.

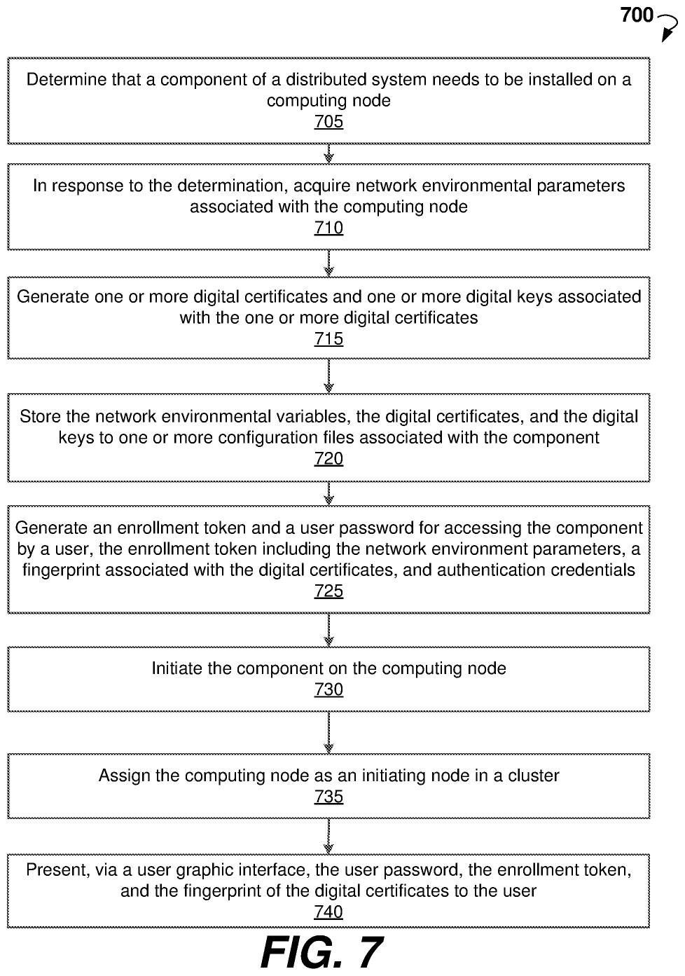

FIG. 7 is a flow chart of an example method 700 for auto-configuration of security features in a distributed system, according to some example embodiments. The method 700 may be performed within an environment 100 illustrated in FIG. 1. Notably, the steps recited below may be implemented in an order different than described and shown in the FIG. 7. Moreover, the method 700 may have additional steps not shown herein, but which can be evident to those skilled in the art from the present disclosure.

The method 700 may commence in block 705 with determining that a component of the distributed system needs to be installed on a computing node. The determination that the component of the distributed system needs to be installed on the computing node may include determining that a user has entered a predetermined command via a user interface.

In block 710, in response to the determination, the method 700 may continue with acquiring network environmental parameters associated with the computing node. The network environment parameters may include one or more of the following: a port of the computing node, an Internet Protocol address of the computing node, a hostname associated with the computing node, and so forth.

In block 715, the method 700 may include generating one or more digital certificates and one or more digital keys associated with the digital certificates. In block 720, the method 700 may include storing the network environmental parameters, the digital certificates, and the digital keys to one or more configuration files associated with the component.

In block 725, the method may include generating an enrollment token and a user password for accessing the component by a user. The enrollment token may include the network environment parameters, a fingerprint associated with the one or more digital certificates, and authentication credentials (an API key).

In block 730, the method 700 may include initiating the component on the computing node. In block 735, the method 700 may include assigning the computing node as an initiating node of a cluster. In block 740, the method 700 may include presenting, via a user graphic interface, the ‘elastic’ user password, the enrollment token, and the fingerprint of the digital certificates to the user.

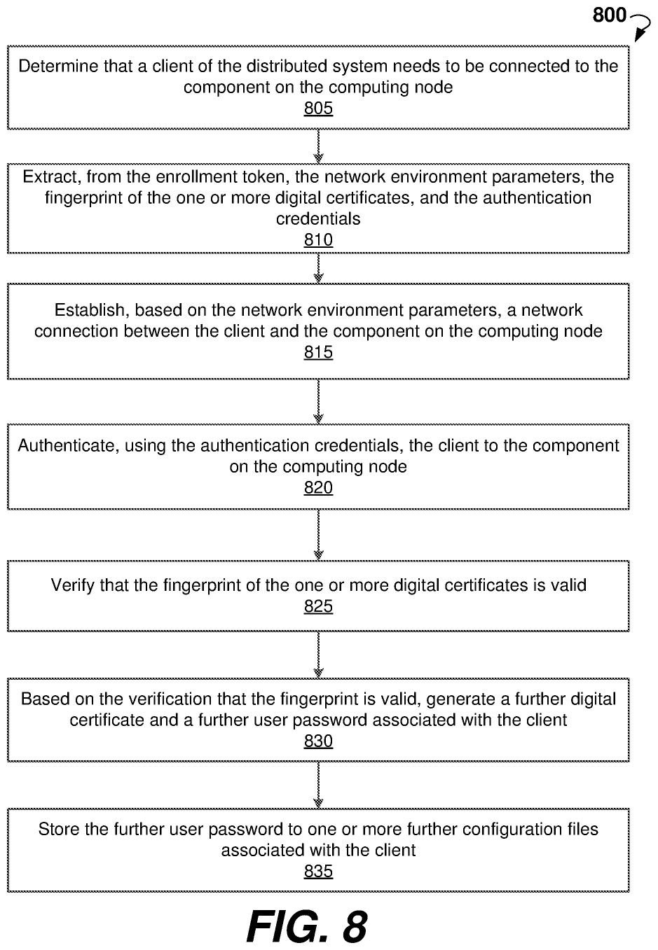

FIG. 8 is a flow chart of an example method 800 for auto-configuration of security features of a client of a distributed system, according to some example embodiments. The method 800 may be a continuation of the method 700 shown in FIG. 7. The method 800 may be performed within an environment 100 illustrated in FIG. 1. Notably, the steps recited below may be implemented in an order different than described and shown in the FIG. 8. Moreover, the method 800 may have additional steps not shown herein, but which can be evident to those skilled in the art from the present disclosure.

In block 805, the method 800 may include determining that a client of the distributed system needs to be connected to a component of the distributed system on the computing node. In block 810, in response to the determination, the method 800 may continue with extracting, from the enrollment token, the network environment parameters, the fingerprint of the one or more digital certificates, and the authentication credentials (the API key).

In block 815, the method 800 may include establishing, based on the network environment parameters, a network connection between the client and the component on the computing node. The digital certificates can be used to establish a secure communication between the component and the client at Hypertext Transfer Protocol layer. In block 820, the method 800 may authenticate, using the API key, the client to the component on the computing node.

In block 825, the method 800 may proceed with verifying that the fingerprint of the one or more digital certificates is valid. In block 830, the method 800 may include generating, based on the verification that the fingerprint is valid, a further password (an authentication token) associated with the client.

In block 835, the method 800 may include storing the further password (the authentication token) to one or more further configuration files associated with the client.

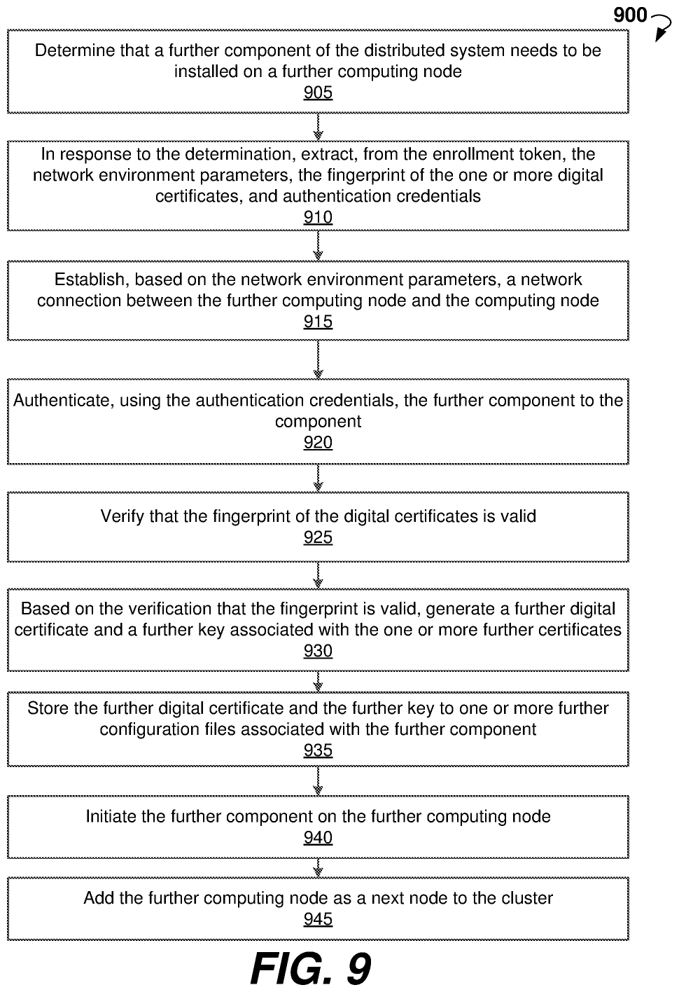

FIG. 9 is a flow chart of an example method 900 for auto-configuration of security features of an additional node in a distributed system, according to some example embodiments. The method 900 may be a continuation of the method 700 shown in FIG. 7. The method 900 may be performed within an environment 100 illustrated in FIG. 1. Notably, the steps recited below may be implemented in an order different than described and shown in FIG. 9. Moreover, the method 900 may have additional steps not shown herein, but which can be evident to those skilled in the art from the present disclosure.

In block 905, the method 900 may proceed with determining that a further component of the distributed system needs to be installed on a further computing node. The determination that the further component of the distributed system needs to be installed on the computing node may include determining that the user has entered a predetermined command via a user interface. The predetermined command may include the enrollment token as a parameter.

In block 910, in response to the determination, the method 900 may include extracting, from the enrollment token, the network environment parameters, the fingerprint of the one or more digital certificates, and authentication credentials (in form of an API key).

In block 915, the method 900 may include establishing, based on the network environment parameters, and authenticating with the API key a network connection between the further computing node and the computing node. In block 920, the method 900 may authenticate, using the API key, the further component to the component on the computing node of the distributed system.

In block 925, the method 900 may include verifying that the fingerprint of the digital certificates is valid.

In block 930, the method 900 may include, based on the verification that the API key and the fingerprint are valid, generating a further digital certificate and a further key associated with the one or more further certificates. The further certificate can be used to establish a secure communication between the component on the computing node and the further component on the further computing node at a transport layer. The further digital certificate can be used to establish a secure communication between the further component and a client at HTTP layer. In block 935, the method 900 may proceed with storing the further digital certificate and the further key to one or more further configuration files associated with the further component.

In block 940, the method 900 may initiate the further component on the further computing node. In block 945, the method 900 may add the further computing node as a next node to the cluster.

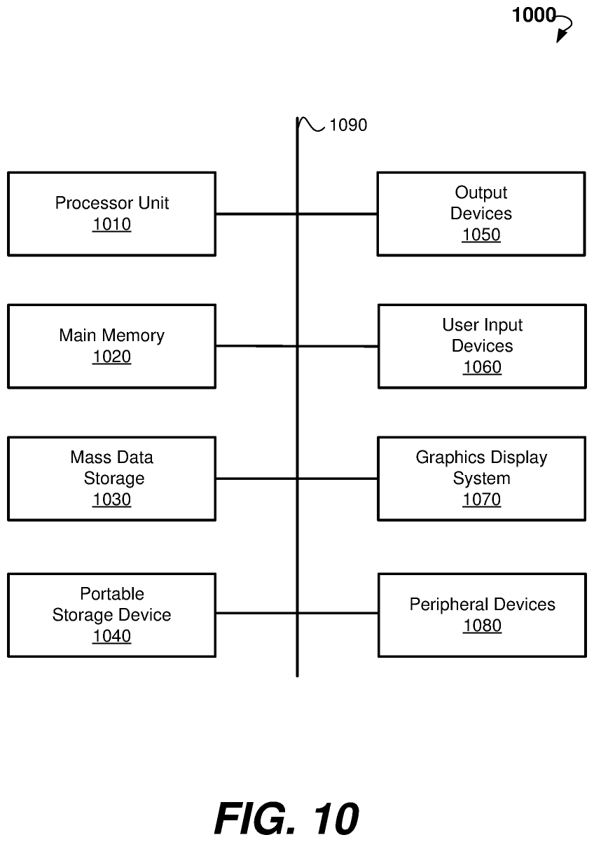

FIG. 10 illustrates an exemplary computer system 1000 that may be used to implement some embodiments of the present disclosure. The computer system 1000 of FIG. 10 may be implemented in the contexts of the likes of a user device 110, one or more node(s) 140, a cluster 150, and a data network 130 shown in FIG. 1. The computer system 1000 of FIG. 10 includes one or more processor units 1010 and main memory 1020. Main memory 1020 stores, in part, instructions and data for execution by processor unit(s) 1010. Main memory 1020 stores the executable code when in operation, in this example. The computer system 1000 of FIG. 10 further includes a mass data storage 1030, portable storage device 1040, output devices 1050, user input devices 1060, a graphics display system 1070, and peripheral device(s) 1080.

The components shown in FIG. 10 are depicted as being connected via a single bus 1090. The components may be connected through one or more data transport means. Processor unit(s) 1010 and main memory 1020 are connected via a local microprocessor bus, and the mass data storage 1030, peripheral device(s) 1080, portable storage device 1040, and graphics display system 1070 are connected via one or more input/output (I/O) buses.

Mass data storage 1030, which can be implemented with a magnetic disk drive, solid state drive, or an optical disk drive, is a non-volatile storage device for storing data and instructions for use by processor unit(s) 1010. Mass data storage 1030 stores the system software for implementing embodiments of the present disclosure for purposes of loading that software into main memory 1020.

Portable storage device 1040 operates in conjunction with a portable non-volatile storage medium, such as a flash drive, floppy disk, compact disk, digital video disc, or Universal Serial Bus (USB) storage device, to input and output data and code to and from the computer system 1000 of FIG. 10. The system software for implementing embodiments of the present disclosure is stored on such a portable medium and input to the computer system 1000 via the portable storage device 1040.

User input devices 1060 can provide a portion of a user interface. User input devices 1060 may include one or more microphones; an alphanumeric keypad, such as a keyboard, for inputting alphanumeric and other information; or a pointing device, such as a mouse, a trackball, stylus, or cursor direction keys. User input devices 1060 can also include a touchscreen. Additionally, the computer system 1000 as shown in FIG. 10 includes output devices 1050. Suitable output devices 1050 include speakers, printers, network interfaces, and monitors.

Graphics display system 1070 can include a liquid crystal display (LCD) or other suitable display device. Graphics display system 1070 is configurable to receive textual and graphical information and process the information for output to the display device.

Peripheral devices 1080 may include any type of computer support device to add additional functionality to the computer system.

The components provided in the computer system 1000 of FIG. 10 are those typically found in computer systems that may be suitable for use with embodiments of the present disclosure and are intended to represent a broad category of such computer components that are well known in the art. Thus, the computer system 1000 of FIG. 10 can be a personal computer (PC), handheld computer system, telephone, mobile computer system, workstation, tablet, phablet, mobile phone, server, minicomputer, mainframe computer, wearable, or any other computer system. The computer may also include different bus configurations, networked platforms, multi-processor platforms, and the like. Various operating systems may be used including UNIX, LINUX, WINDOWS, MAC OS, PALM OS, QNX, ANDROID, IOS, CHROME, TIZEN, and other suitable operating systems.

The processing for various embodiments may be implemented in software that is cloud-based. In some embodiments, the computer system 1000 is implemented as a cloud-based computing environment, such as a virtual machine operating within a computing cloud. In other embodiments, the computer system 1000 may itself include a cloud-based computing environment, where the functionalities of the computer system 1000 are executed in a distributed fashion. Thus, the computer system 1000, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computer system 1000, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

The present technology is described above with reference to example embodiments. Therefore, other variations upon the example embodiments are intended to be covered by the present disclosure.

What is claimed is:

1. A method for auto-configuration of security features in a distributed system, the method comprising:
determining that a component of the distributed system needs to be installed on a computing node;
in response to the determination, acquiring network environmental parameters associated with the computing node;
generating one or more digital certificates and one or more digital keys associated with the one or more digital certificates;
storing the network environmental parameters, the one or more digital certificates, and the one or more digital keys to one or more configuration files associated with the component;
generating an enrollment token and a user password for accessing the component by a user, the enrollment token including the network environment parameters, a fingerprint associated with the one or more digital certificates, and authentication credentials;
initiating the component on the computing node; and
assigning the computing node as an initiating node of a cluster.

2. The method of claim 1, wherein the network environment parameters include one or more of the following: a port of the computing node, an Internet Protocol address of the computing node, and a hostname associated with the computing node.

3. The method of claim 1, further comprising presenting, via a user graphic interface, the user password, the enrollment token, and the fingerprint of the one or more digital certificates to the user.

4. The method of claim 1, wherein the determining that the component of the distributed system needs to be installed on the computing node includes determining that the user has entered a predetermined command via a user interface.

5. The method of claim 1, further comprising:
determining that a client of the distributed system needs to be connected to the component on the computing node; and
in response to the determination:
extracting, from the enrollment token, the network environment parameters, the fingerprint of the one or more digital certificates, and the authentication credentials;
establishing, based on the network environment parameters, a network connection between the client and the component on the computing node;
authenticating, using the authentication credentials, the client to the component on the computing node;
verifying that the fingerprint of the one or more digital certificates is valid;
based on the verification that the fingerprint is valid:
generating a further user password associated with the client; and
storing the further user password to one or more further configuration files associated with the client.

6. The method of claim 5, wherein the one or more digital certificates is used to establish a secure communication between the component and the client at Hypertext Transfer Protocol layer.

7. The method of claim 1, further comprising:
determining that a further component of the distributed system needs to be installed on a further computing node; and
in response to the determination:
extracting, from the enrollment token, the network environment parameters, the fingerprint of the one or more digital certificates, and the authentication credentials;
establishing, based on the network environment parameters, a network connection between the further computing node and the computing node;
authenticating, using the authentication credentials, the further component to the component;
verifying that the fingerprint of the one or more digital certificates is valid;
based on the verification that the fingerprint is valid:
generating a further digital certificate and a further key associated with the one or more further certificates;
storing the further digital certificate and the further key to a further configuration file associated with the further component;
initiating the further component on the further computing node; and
adding the further computing node as a next node to the cluster.

8. The method of claim 7, wherein the determining that the further component of the distributed system needs to be installed on the computing node includes determining that the user has entered a predetermined command via a user interface, the predetermined command including the enrollment token as a parameter.

9. The method of claim 7, wherein:
the digital certificate is used to establish a secure communication between the component and the further component at a transport layer; and
the further digital certificate is used to establish a secure communication between a client and the further component at a Hypertext Transfer Protocol layer.

10. The method of claim 7, wherein:
the network environment parameters include a port associated with the computing node; and
the computing node is configured to listen to the port for a verification request from the further computing node.

11. A system for auto-configuration of security features in a distributed system, the system comprising:
at least one processor; and
a memory communicatively coupled to the processor, the memory storing instructions executable by the at least one processor to perform a method comprising:
determining that a component of the distributed system needs to be installed on a computing node;
in response to the determination, acquiring network environmental parameters associated with the computing node;
generating one or more digital certificates and one or more digital keys associated with the one or more digital certificates;
storing the network environmental parameters, the one or more digital certificates, and the one or more digital keys to one or more configuration files associated with the component;
generating an enrollment token and a user password for accessing the component by a user, the enrollment token including the network environment parameters, a fingerprint associated with the one or more digital certificates, and authentication credentials;
initiating the component on the computing node; and
assigning the computing node as an initiating node of a cluster.

12. The system of claim 11, wherein the network environment parameters include one or more of the following: a port of the computing node, an Internet Protocol address of the computing node, and a hostname associated with the computing node.

13. The system of claim 11, wherein the at least one processor is configured to present, via a user graphic interface, the user password, the enrollment token, and the fingerprint of the one or more digital certificates to the user.

14. The system of claim 11, wherein the determining that the component of the distributed system needs to be installed on the computing node includes determining that the user has entered a predetermined command via a user interface.

15. The system of claim 11, wherein the at least one processor is configured to perform the following operations:
determining that a client of the distributed system needs to be connected to the component on the computing node; and
in response to the determination:
extracting, from the enrollment token, the network environment parameters, the fingerprint of the one or more digital certificates, and the authentication credentials;
establishing, based on the network environment parameters, a network connection between the client and the component on the computing node;
authenticating, using the authentication credentials, the client to the component on the computing node;
verifying that the fingerprint of the one or more digital certificates is valid;
based on the verification that the fingerprint is valid:
generating a further user password associated with the client; and
storing the further user password to one or more further configuration files associated with the client.

16. The system of claim 15, wherein the one or more further digital certificates is used to establish a secure communication between the component and the client at Hypertext Transfer Protocol layer.

17. The system of claim 11, wherein the at least one processor is configured to perform the following operations:
determining that a further component of the distributed system needs to be installed on a further computing node; and
in response to the determination:
extracting, from the enrollment token, the network environment parameters, the fingerprint of the one or more digital certificates, and the authentication credentials;
establishing, based on the network environment parameters, a network connection between the further computing node and the computing node;
authenticating, using the authentication credentials, the further component to the component;
verifying that the fingerprint of the one or more digital certificates is valid;
based on the verification that the fingerprint is valid:
generating a further digital certificate and a further key associated with the one or more further certificates;
storing the further digital certificate and the further key into a further configuration file associated with the further component;
initiating the further component on the further computing node; and
adding the further computing node as a next node to the cluster.

18. The system of claim 17, wherein the determining that the further component of the distributed system needs to be installed on the computing node includes determining that the user has entered a predetermined command via a user interface, the predetermined command including the enrollment token as a parameter.

19. The system of claim 17, wherein:
the digital certificate establishes a secure communication between the component and the further component at a transport layer; and
the further digital certificate establishes a secure communication between a client and the further component at a Hypertext Transfer Protocol layer.

20. A non-transitory computer-readable storage medium having embodied thereon instructions, which when executed by at least one processor, perform steps of a method, the method comprising:
determining that a component of the distributed system needs to be installed on a computing node;
in response to the determination, acquiring network environmental parameters associated with the computing node;
generating one or more digital certificates and one or more digital keys associated with the one or more digital certificates;
storing the network environmental parameters, the one or more digital certificates, and the one or more digital keys to one or more configuration files associated with the component;
generating an enrollment token and a user password for accessing the component by a user, the enrollment token including the network environment parameters, a fingerprint associated with the one or more digital certificates, and authentication credentials;
initiating the component on the computing node; and
assigning the computing node as an initiating node of a cluster.
